(19) United States
(12) Patent Application Publication
(10) Pub. No.: US 2007/0078693 A1
(43) Pub. Date: Apr. 5, 2007

(54) Method of Process Review and Solutions Development

(76) Inventor: Raymond Kaelin, Sparta, NJ (US)

Correspondence Address: GREENBERG & LIEBERMAN, LLC, 2141 WISCONSIN AVE, N.W., SUITE C-2, WASHINGTON, DC, 20007, US

(21) Appl. No.: 11/464,407

(22) Filed: Aug. 14, 2006

Related U.S. Application Data
(60) Provisional application No. 60/595,876, filed on Aug. 12, 2005.

(51) Int. Cl. G06F 17/50

(52) U.S. Cl. 705/7

(57) ABSTRACT

A method of analyzing and recommending improvements to a company's workflow is disclosed. Meetings with multiple employees involved in the workflow are combined into one meeting, and the employees are encouraged and prompted to answer questions jointly. A guided approached is used utilizing a series of basic guiding principles for developing ‘best practice’ improvements that are ‘best for the business’. It is reengineering without the use of external subject matter reengineering experts. The employees themselves are empowered to be reengineering experts through the application of these techniques in a joint session, guided by the workshop leader. As a result, recommendations and conclusions are arrived at not just by experts hired, but also by the employees in a joint, participative process. Technology is employed to facilitate the meetings with active storyboarding even though employees are at different physical locations.

### FIELD OF THE INVENTION

The present invention relates to both methods of review of the workplace and solution development through either changed work practices or technology tool implementation; or both. More specifically, the present invention relates to auditing of the workplace, wherein individual employees are interviewed, educated and given guidance on process improvement through solution design and development so that a better workflow can be achieved.

### BACKGROUND OF THE INVENTION

The goal of every business is to earn money and in every business's quest to earn money, workflow often becomes the primary concern, so that the most productive and efficient methods can be employed to generate as much income as possible. Traditionally, a business will hire a group of people to come into the business and interview various employees responsible for different duties. For example, interviews would be conducted with someone who actually does the sales for a particular product of the company. Other interviews would be conducted with those who actually process the orders for those sales for the particular company, and still other interviews would be done with those that actually make the product that is being sold by that particular company.

Needless to say, a traditional method of data gathering is time consuming, disjointed and very expensive. Often times, an interview with somebody that is in charge of billing at a particular company might not just be hosted or conducted by one individual who has been hired by the company. Usually, a specialist would partake in the interview. That specialist would be skilled in some of the best methods of improving efficiency and productivity. In addition, an individual with knowledge of the supply-side chain of the business might join the meeting. In addition, an individual with knowledge of the production side might join the meeting, and even further, someone with knowledge of the sales side of the business might join the meeting.

So restated, although one employee of the company is actually present during the interview, those conducting the interview might number four or more people who have been hired by the company to conduct the interview. It is easy to see that if four experts or more are needed to conduct one interview, and if there are multiple employees at a company being interviewed, how much time and how much cost is involved just in conducting the interviews themselves. Thus, it is desirable to have a method of data gathering that is more efficient, is less costly and hopefully, more productive than paying four or more individuals, who are experts, to spend a half hour, an hour, or more, with each employee at a company just to get a sense for what the current methods of doing business are at the company.

Further, the traditional method of auditing a company for workflow improvements calls for discreet interviews with employees to gather data, and then relies on the experts who have been hired by the company to put that data together and make recommendations to the company. While the experts are hired because they have great knowledge in certain areas, there is little ability for any input from the employees into the conclusions or recommendations that are made by the experts hired by the company. In a sense, the experts are gathering data, gathering information, making a recommendation, but the recommendation is solely based on the interviews. Thus, information flows unilaterally from the employees to the experts, but there is no bilateral feedback or communication once the experts have collated the data, reviewed the data, formed conclusions and are either ready to make recommendations or design a proposed solution.

Thus, there is a need for a method of reviewing the workflow of a company and recommending solutions that does not cancel out the actual individuals performing the work when making conclusions. In addition, employees must not be merely interviewed but brought into the solution process by being allowed to participate in the development of the solution itself. This is accomplished through an interactive process involving a joint assessment period with their peers. It is where employees are both educated on process reengineering techniques as well as directly solicited for participative ideas, recommendations and solutions to the processes under analyses.

Restated, there is a need for a workflow analysis that does not just collect data from employees of a company, but allows the employees to partake and participate in the actual analysis of the process, the identification of the needed improvements required as well as (and most importantly) the actual solution (or solutions) itself.

Furthermore, there is a need to improve the flow of communication when conducting an analysis of the workflow of a business. Often times, those hired to recommend solutions to workflow problems, or those hired to recommend better workflow practices, come to conclusions after much deliberation and thought amongst themselves. It is desirable to improve the communication flow between the actual employees, who are performing the work, and the experts brought in to recommend workflow solutions, so that multiple recommendations from those hired to improve the workflow do not contradict one another. It is commonplace for experts brought in to analyze the workflow, to form solutions and recommendations that are incompatible.

For example, an expert team brought in to improve workflow might talk to somebody responsible for sales in the company, and after several interviews with the person responsible for sales, the experts hired to make recommendations for the workflow might recommend that the sales person focus more time on sales and less time on actually planning where that salesperson will be traveling. Unfortunately, the team hired to improve the workflow, after conducting interviews with somebody in charge of billing in the company, might come to the conclusion that costs for sales travel can be controlled if the salesman more closely communicates with the person in billing, even though such a recommendation would require the salesperson to spend more time planning where that salesperson is going to travel. Such contrary recommendations can occur, simply because there are different teams of experts traditionally working with different groups of employees in a company that is being analyzed.

There is a need to make the whole analysis and recommendation process more cohesive and to improve the communication between the parties being analyzed, as well as the actual individuals hired to perform the analysis and conclusion.

### SUMMARY OF THE INVENTION

The present invention is a method for analyzing companies as well as developing solutions that is time-compacted, synergistic and cost effective. The present invention promotes data gathering and solutions development via a joint dynamic process. According to the present invention, experts hired to evaluate a company meet not just with one employee of the company at a time, but a gathering of employees is fostered. By bringing several employees from the company together, interviewing them jointly and at the same time, more reliable data can be collected, as opposed to discreet interviews with each individual employee.

Furthermore, the present invention promotes conversation, information exchange, negotiation and prioritization between the participants during the interview, and not just between those hired to analyze the company and the employees, but actually between the employees of the company—often times for the first time. Thus, in the present invention, rather than unilateral discussions, where information is flowing merely from a company's employee to the evaluators, in the present invention, information flows from one company employee to another company employee, and often times, data is gathered as those hired to evaluate the company listen to a discussion amongst the employees. Because the employees are actually talking to one another in the presence, or under the guidance, of those hired to evaluate the company, the employees assist in formulating recommendations and conclusions, as opposed to the traditional method of evaluating a company, where the employees provide information unilaterally and there is no bilateral discussion. In particular, these conversations result in a better understanding of the relative significance of each issue, as they are compared and contrasted against each other by a joint group—who can negotiate amongst themselves as to the relative importance of each issue being discussed.

Essentially, the present invention brings a group of employees that work together into a meeting with specialists and experts that have been hired to evaluate a company. Because of the dialogue that is created with various employees present, in addition to those present who have been hired to evaluate the company, a vaster, better and more cost effective result emerges.

In addition, these employees are given training, guidance and direction on the application of reengineering principles that form the basic operating methods for effective solution development and improvement design. There's no need to pay for an extensive list of specialists and subject matter experts in reengineering best practice, because the employees themselves are empowered with the tools—coupled with their innate knowledge of the business—to create ‘best practices’ that are actually their solutions on what works best for their specific business model.

Because of the present invention, an evaluation and recommendation of a company's workflow is more accurate, costs less and truly reflects not just what those hired to evaluate the company believe the workflow should be, but actually represents a realistic solution for the employees, as well.

### DETAILED DESCRIPTION OF THE PRESENT EMBODIMENT

According to the present invention, the analysis of a company for workflow purposes, and providing recommendations and conclusions for improving workflow in a company, is made better because there is a fundamental change in the way that information is gathered, recorded and shared.

The first step in the method of the present invention is to take the experts that have been hired to evaluate a company's workflow, and allow them to meet with not just one employee in the company, but with a group of employees in the company, that represent different facets of the tasks that the company performs. For example, according to the present invention, if there are several experts hired that would normally interview an employee in the billing section of a company, those experts would meet not just with the employee in the billing section, but at the same time, in the same meeting, would also meeting with someone from the company's sales section, and at the same time in the same meeting, would also meet with somebody from the company's order processing section, and at the same time, would also meet in the same meeting, with somebody from the company's production section. The goal is to have, in this example, four employees of the company, each from a different facet of the company's workflow, to interview together with the experts hired to evaluate the workflow of the company.

Such a meeting traditionally is not always possible and, thus, the present invention calls for technology to be employed to allow such a meeting to occur. For example, often the production site might be in China; the sales site might be located in the United States; the billing site might be located in India, et cetera.

Thus, bringing employees who are representative of different facets of the workflow traditionally has not been possible, and although using a telephone, the employees of the company might be able to communicate, the present invention calls for a dynamic presentation to be used, so that all parties can see one another and talk to one another, and preferably, work together, as they speak and look at the same images as they speak. Conventional technology is thus called upon in the present invention to allow an employee from China to meet at the same time with an employee in the United States, to meet at the same time with an employee in India, and to meet at the same time with experts who might be in Canada.

Using technology such as the internet with collaborative story-boarding, the present invention is able to promote the kind of communication that is necessary to achieve a better result. Conventional technology, such as WebEx™ or NetMeeting™ allows all the participants in a meeting, experts and employees of a company, to see one another, talk to one another, share ideas, formulate conclusions and arrive at a recommendation that is realistic, and not contradictory. According to the present invention, at least two employees of a company should be brought into a meeting with the experts. Preferably, a meeting would consist of six to sixteen people. More than sixteen people in a meeting might prove to be not terribly constructive, as too many opinions and too many voices need to be heard to reach a conclusion, whereas less than six people does not allow for much bilateral discussion, as typically, there could be three or four experts brought into a meeting, and there would only be room left for two employees, and only two employees rarely will represent enough of the actual people who are part of the workflow that is being studied.

The second step of the present invention is for the experts in a meeting to ask questions of the employees in the meeting, much like traditional data gathering in a traditional analysis of a company's workflow. However, in the present invention, because more than one employee is present in the meeting, a question can receive two answers, which might be somewhat complementary, or it might be somewhat contradictory, because at least two employees are present during the meeting.

The traditional method would call for a unilateral flow of information. In the present invention, the third step requires bilateral flow of information, meaning questions are not just asked of the employees in the meeting, but the employees themselves are prompted to work directly with the experts, and even ask the experts questions, if necessary.

Another step of the present invention calls for the employees to talk to one another. This is a dramatic difference when the present invention is compared to the traditional methods of analyzing companies. With the employees talking to one another during the meeting, and not just to the experts, the employees can provide a cohesive and better balanced answer to the experts' questions, than if the employees were interviewed in isolated conditions.

Another step of the present invention calls for story-boarding of the workflow, so that all the employees can actually see the workflow, and the story-boarding can be edited by any one of the participants in the meeting, meaning that an expert could modify the story-boarding, and so just as easily, could the employee. Thus, the story-boarding and presentation of the workflow is not just made by the experts, and modified by the experts for the benefit of one employee, but the story-boarding is actually a collaborative effort amongst experts and employees. The present invention also includes the step of employees and experts arriving at conclusions and recommendations together. Unlike the traditional method of analyzing the workflow of a company, the present invention, because of the nature of the meeting, where experts and employees directly involved in the workflow, are all meeting together, is able to produce a recommendation and conclusion that is not just theoretical on the part of the experts, but actually, can be practically applied because it also has been arrived at by the employees, who are part of the meeting of the present invention.

Please note that when referring to the present invention and describing or using the term “the experts”, it can mean between one to three workshop leaders. Normally, there is only one workshop leader with an aide documenting the output and managing the media being utilized.

The present invention also calls on the employees, who are to be present at the meetings of the present invention, to go through a series of questions, or preliminary exercises that will properly prepare the employees for the meetings of the present invention. For example, the employees would make lists of what vision they have for the workflow from their perspective. That vision(s) would be broken down into what technology requirements are necessary to reach a desired solution, what reengineering best practices need to be implemented, what process requirements are necessary to reach a desired solution, and what key issues that are technology-related and process-related, are truly needed to improve the workflow.

Thus, the present invention would encourage the employees to, before and during the meeting, or at least during the meeting, to rank in order of importance, the different requirements necessary to make a solution happen. By preparing before the meeting, and continuing to offer solutions during the meeting, the employees provide answers, and not just information. The employees, along with the experts in the meeting, are able to perform gap analyses according to the present invention. A gap analysis is made between what is the current state of the art, or the current state of affairs, in the workflow of the company, versus what could be the state of the art in current workflow in the company.

The employees and the experts jointly establish a draft set of requirements. Change requirements are arrived at to bring the organization or the company from the “as is” to the “to be,” or in other words, from the current state to the desired state, and a draft set of requirements is established, or system data requirements, that are actually necessary to develop the desired solution. A prioritization grid is made, so that decisions can be made on which areas to focus on first to reach the desired solutions of the company. A prioritization grid would use factors such as the level of impact, the time requirement, the resources required, the degree of difficulty, and put them together, so that an overall score can determine the priority for each solution or action.

For example, there could be process solutions, such as closing and reporting, budgeting, forecasting and sales reporting. The level of improvement or impact, the time required, the effort required (meaning the resources and costs), and the degree of difficulty and complexity, would all be factored into the prioritization grid, so that a summary for each process solution could be arrived at, and that which has the lowest summary score would be the easiest process solution to employ first.

I claim:

1. A method for business workflow analysis, comprising:
an expert asking questions of employees;
the expert sharing reengineering techniques to be utilized by the employees in a joint analyses and solution development session;
the employees discussing answers to the questions while replying to the expert; and
the expert and the employees arriving at joint solutions to workflow problems.

2. The method of claim 1, wherein the employees represent different facets of the tasks that a company performs.

3. The method of claim 1, wherein the expert and the employees communicate via the internet.

4. The method of claim 1, wherein the expert and the employees communicate with collaborative storyboarding.

5. The method of claim 1, wherein the expert and the employees number at least six but not more than sixteen people.

6. The method of claim 1, wherein the expert is joined by other experts.

7. The method of claim 1, wherein the expert and the employees perform gap analyses.

8. The method of claim 1, wherein the expert and the employees make a prioritization grid.
